(19) United States
(12) Patent Application Publication
(10) Pub. No.: US 2004/0128165 A1
(43) Pub. Date: Jul. 1, 2004

(54) Method and apparatus for accessing and synchronizing multiple health care databases

(76) Inventors: Brad J. Block, Doylestown, PA (US); Carolyn G. Muhlbauer, Hilltown, PA (US); Patricia J. Witek, Doylestown, PA (US); Julie E. Fenley, Ambler, PA (US); Ted Harrison, Whitby (CA)

Correspondence Address: Pepper Hamilton LLP, One Mellon Center, 50th Floor, 500 Grant Street, Pittsburgh, PA, 15219, US

(21) Appl. No.: 10/680,722

(22) Filed: Oct. 7, 2003

Related U.S. Application Data
(60) Provisional application No. 60/416,615, filed on Oct. 7, 2002.

(51) Int. Cl. G06F 17/60; G06F 7/00; G06F 17/30

(52) U.S. Cl. 705/2; 707/3

(57) ABSTRACT

A method and computer-based system for providing an interface between multiple users and a plurality of databases used in providing healthcare services is disclosed. The system may include a central repository and databases containing information regarding patient instructions, medical necessity testing, scheduling, third party payers, procedure results, registration and order entry, patient records, hospital records and/or physician records. The system may interconnect physician offices, hospitals, remote healthcare facilities and/or patient-accessible locations. The system may allow physicians and patients to provide clinical and scheduling information to remote healthcare providers, synchronize databases between remote locations, and provide feedback on scheduled appointments and upcoming or completed procedures.

### CLAIM OF PRIORITY

This application claims priority to U.S. provisional patent application No. 60/416,615, filed Oct. 7, 2002, entitled “Method and Apparatus for Accessing and Synchronizing Multiple Health Care Databases,” which is incorporated herein by reference in its entirety.

### FIELD OF THE INVENTION

The present invention relates to methods and systems for managing health care patient services. More particularly, this invention relates to a computer system for providing an interface between multiple users and multiple databases used in providing healthcare services.

### BACKGROUND OF THE INVENTION

The complexity of database and information systems has created an environment where information is not easily shared, processed, or synchronized among diverse sets of independent yet affected systems. As a result, significant systematic inefficiencies are present and require additional resources in accessing and maintaining systems.

Databases in the healthcare industry, for example, are particularly complex and unsynchronized. Physicians, hospitals and insurance companies each use separate databases to, for example, schedule appointments, verify medical histories, confirm insurance coverage and medical necessity, issue patient instructions, issue physician instructions, and generally coordinate services provided to the patients. Moreover, these databases are used to coordinate the processes related to and supporting patient care.

In addition, government legislation has continued to impact the healthcare industry. In 1996, Congress passed the Health Insurance Portability and Accountability Act (HIPAA) in an attempt to eliminate inefficiencies, reduce paperwork, and detect and prosecute fraud in the healthcare industry. Furthermore, HIPAA enables workers to maintain insurance coverage even if they should change jobs with pre-existing medical conditions. HIPAA also places stringent privacy requirements on the use of data to insure that patients' medical records are protected. As a result, providers of healthcare databases and systems must insure that their products and services are HIPAA-compliant.

Many parties are involved in both providing healthcare services and managing data associated with the services. Significant operational inefficiencies and an inability to proactively manage patient customer service experiences can result. For example, patient data must be entered and re-entered at multiple locations. This can cause delays, increase the opportunity for errors, and delay the identification of patient insurance eligibility issues until the time of the procedure. As a result, many customers of outpatient or inpatient services are faced with paperwork that is incorrect and are required to submit additional paperwork or perform additional steps to rectify the situation.

As an example, when a patient visits his/her physician, the physician may prescribe certain procedures to be performed at a larger facility such as a hospital. The patient contacts the hospital directly, provides his/her personal and insurance information, which was previously provided to the physician, to the hospital, and schedules the procedure. Upon arrival for the procedure, the hospital will confirm insurance eligibility based on the medical necessity of the procedure for the particular diagnosis. Because of system limitations, this eligibility test is not performed in advance of the patient's visit. In the event that insurance coverage cannot be verified, an error occurred during data entry, or some other difficulty has manifested itself, the scheduled procedure may not be approved or the patient may have to pay for the procedure at the time of service and resolve the coverage issue at a later time. Alternatively, the patient may choose to not undergo the procedure. Such a decision is not necessarily disclosed to the physician who initially requested the procedure. As such, the physician's database and information systems and the hospital's database and information systems may become unsynchronized if they do not transfer patient, physician, insurance and procedure information in a timely and efficiently manner. Because the patient is required to provide the same information to both the hospital and the physician, data inconsistencies may result. Moreover, since the physician's orders are manually transmitted, miscommunication of orders, submission of incomplete orders or even loss of orders can occur. Furthermore, coverage and eligibility are only confirmed at the time of the procedure. No system or method in the prior art allows for the proactive management of the patient experience by resolving issues prior to the patient presenting himself/herself for the procedure. In such an environment, considerable resources are expended in a reactionary fashion.

Medical necessity is a healthcare industry practice that considers whether the requested procedure is appropriate based on the physician's diagnosis. For example, if the physician's diagnosis stated that the patient has a viral infection, a procedure such as a CAT scan or an MRI is not likely to be deemed appropriate. In this case, a third party payer would likely decline coverage for such a procedure. Medical necessity testing is, thus, a key element of the healthcare services industry. However, it is not typically checked prior to the patient presenting for the scheduled test, procedure or other service.

Generally, in the healthcare environment, two types of services are performed: technical (i.e., hospital-based activity) and professional (i.e., physician-based activity). In some instances, the patient may, for cost or other reasons, refuse a medical service. For example, a physician may recommend chest x-rays for a patient who is experiencing chest pain. The patient may go to the hospital for the procedure, but may decline, for any number of reasons, to have the procedure performed. The patient's refusal to undergo the procedure is not typically reported to the physician or recorded on each of the databases tracking the patient.

As with any large database, healthcare databases present the opportunity for multiple records to exist within the database. Typical database systems periodically examine their data for duplicate or multiple records. Such records may be merged or purged depending upon the system's structure. The purging or merging of multiple records is generally limited to database or information systems operated by a single entity. Thus, affected external or independent database or information systems would not automatically perform similar purging or merging activities. Healthcare systems do not provide the ability to communicate occurrences of multiple records between databases. Moreover, new records are often added from many disparate sources, which increases the chance that duplicate records will occur.

The present invention is directed to solving one or more of the problems described above.

### SUMMARY OF THE INVENTION

A preferred embodiment of the present invention includes a computer-based system that provides an interface between multiple users and a plurality of databases used in providing healthcare services. The preferred system may serve as a repository for commonly accessed data in the healthcare environment. The system may proactively handle patient matters. The system is preferably HIPAA-compliant to ensure the highest level of privacy and data integrity.

A preferred embodiment of the present invention includes a computer system having a unified front-end interface coupled with a repository, the repository providing for temporary storage of records retrieved from a plurality of independent database and information systems. The preferred system is able to access, share, and/or synchronize data across a multitude of independent healthcare database and information systems. In one embodiment, the invention may be applied to outpatient services, although it is no way limited to those services but may easily be used within the hospital or physician office environment.

This preferred repository stores information from a multitude of independent database and information systems used in the tasks of flexible sequencing, eligibility determination, authorization, scheduling, medical necessity, insurance verification, procedure ordering, physician information, patient instruction, patient information, registration and/or order entry. The preferred system facilitates the streamlining of operations, the reduction of inefficiencies, and the minimization of paperwork while providing a comprehensive record of patient services, approvals, and/or procedure results. The unified front-end interface and repository of the preferred embodiment support numerous points of access, including physician offices, hospital remote locations, hospitals, patient residences, and/or other points of service.

A preferred embodiment includes a front end software module which provides an interface permitting healthcare workers to administer a plurality of patient services, a repository module storing patient related information, and a plurality of communication interfaces between the front end software module, a plurality of external databases and information systems, and the repository module.

The invention preferably allows tests such as medical necessity to be completed prior to the patient presenting himself/herself for a procedure. For a hospital procedure, it is common for medical necessity to be considered separately for both the technical and professional components. In certain situations, it is possible for the medical necessity test to pass for the technical component and to fail for the professional component, which may cause patient confusion. The preferred embodiment enables medical necessity testing to be completed for both technical and professional components in advance, which is novel in the health care industry. In addition, the preferred embodiment enables medical necessity testing to be completed prior to the patient presenting himself for the procedure, enabling potential service problems to be identified and resolved in advance.

In a preferred embodiment, a user performs the medical necessity test by querying a database to verify medical necessity for the procedure based on information provided by the physician's diagnosis. The results of the query are preferably stored in the repository with the patient information. Should that database or another database involved in the healthcare process identify a problem with the procedure, the preferred interface provides immediate feedback to the user and generates a report highlighting the problem. Suitable measures may then be undertaken to address the problem through follow-up contact.

A preferred embodiment allows issues such as incomplete orders, incorrectly entered procedure/diagnosis codes, missing physician signatures and similar issues to be resolved in advance of the patient presenting himself/herself for the procedure. The preferred embodiment accomplishes this through an interface to access patient insurance information in confirming eligibility. Pertinent information is then stored in a repository.

The preferred embodiment addresses the issue of refusal of service by capturing this information and storing it in the repository. The repository transmits the information to a physician system, so that a physician can address the situation. This capability could also provide support to the physician should a patient attempt to sue the physician for negligence or malpractice when the patient refused a procedure.

The preferred embodiment addresses the problem of multiple records by facilitating the reduction of multiple patient identifier occurrences across healthcare database and information systems. When a service request is initiated, the preferred interface receives patient search criteria from database and information system. The patient search criteria contain a variety of information used to identify a patient (e.g., name, social security number, birth date, phone number). The preferred interface then queries a first database containing patient search criteria. If no matches are found between the query and the plurality of patient records, the preferred interface performs a search to determine a patient's past hospital activity, if any. If past hospital activity is found, the preferred embodiment prevents the user from adding a new patient identifier. Existing patient records are displayed to allow the user to select a record matching the patient. If no past hospital activity is found, the preferred embodiment permits a new patient record to be created and added to the first database. Preferably, this information is also stored in the repository and a second database. In the event that the second database determines that the newly added patient has a previous record, the preferred interface automatically stores that information in the repository and informs the first database that a multiple record has been created so that it may be merged in near real-time. The preferred repository automatically informs other affected and independent databases of the potential for multiple medical records. This allows a plurality of dependent and independent database and information systems to realize much greater data quality, integrity and consistency, resulting in operational efficiencies and competitive advantages for the user.

The preferred embodiment also provides a computer-based method for managing exceptions to patient processes in a hospital environment. This exceptions-based reporting may allow for the proactive management of potential problems with processes including, but not limited to, unsigned orders, failed medical necessity, appointments without eligibility referral, orders received without appointment, eligibility not passed, referral required but not requested, and a list of pending referrals. Preferably, this exception reporting occurs substantially close to the time of physician ordering, with the exceptions being stored in the repository. The preferred embodiment permits monitoring the repository for exceptions and generating reports indicating that an exception has occurred. This monitoring may occur prior to the patient presenting himself for service at the hospital.

Furthermore, the preferred embodiment provides a method of associating orders with scheduling and patient information retrieved from a first database. A patient-specific information dataset is created based on the association between the order information dataset and the scheduling information dataset. The patient-specific information dataset may be transmitted to at least one external database or information system. This allows a significant reduction in the number of process steps in a typical healthcare environment by facilitating the sharing of data across a plurality of independent database and information systems. As a result, operational inefficiencies are significantly reduced, while patient service levels are improved, offering competitive advantages to the user.

The preferred embodiment also complies with HIPAA requirements and assists in streamlining inefficiencies, reducing paperwork, and/or aggregating patient information including eligibility and authorization that would help to detect and prosecute fraud. The preferred invention provides affected systems with updated patient information in near real-time allowing workers, even in career transition, to have access to healthcare based on their current insurance coverage.

### BRIEF DESCRIPTION OF THE DRAWINGS

Aspects, features, benefits and advantages of the embodiments of the present invention will be apparent with regard to the following description, appended claims and accompanying drawings where:

FIG. 1 illustrates a user-relationship diagram for a preferred embodiment of the present invention;

FIG. 2 illustrates a preferred system architecture including servers and database systems;

FIG. 3 illustrates a context diagram for the preferred embodiment;

FIG. 4 illustrates a flow diagram for medical necessity testing;

FIGS. 5A and 5B illustrate a flow diagram for a procedure crosswalk; and

FIG. 6 illustrates exemplary field data for a procedure crosswalk table or database;

FIG. 7 illustrates an exemplary computing device that is capable of implementing system embodiments of the invention;

FIG. 8 illustrates exemplary components of the computer of FIG. 7.

### DETAILED DESCRIPTION OF THE PREFERRED EMBODIMENTS

Before the present structures, systems and methods are described, it is to be understood that this invention is not limited to particular structures, systems, methodologies or protocols described, as these may vary. It is also to be understood that the terminology used in the description is for the purpose of describing the particular versions or embodiments only, and is not intended to limit the scope of the present invention.

It must also be noted that as used herein, the singular forms “a,” “an” and “the” include plural references unless the context clearly dictates otherwise. Thus, for example, reference to an “database” is a reference to one or more databases and equivalents thereof known to those skilled in the art, and so forth. Unless defined otherwise, all technical and scientific terms used herein have the same meanings as commonly understood by one of ordinary skill in the art. Although any methods, devices and material similar or equivalent to those described herein can be used in the practice of testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

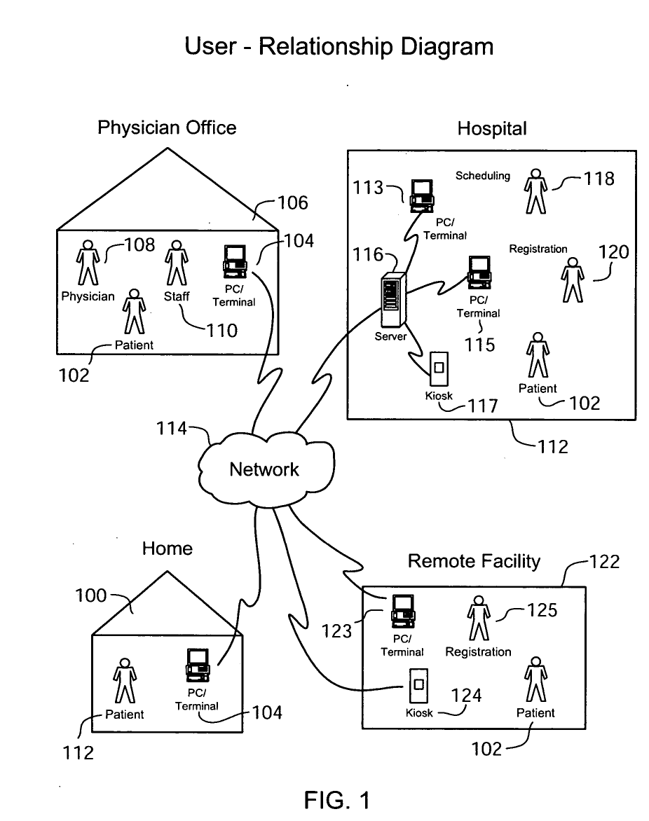

With reference to the drawings, in general, and FIGS. 1 through 8 in particular, a preferred method and apparatus of the present invention are disclosed.

FIG. 1 illustrates a preferred user-relationship diagram that references the relationships within a healthcare services environment. A patient 102 may obtain access to healthcare services via a computer connection 104 at a location 100 that is not a physician's office 106, a hospital 112, or a remote healthcare site 122. The patient 102 may obtain access through a communications network 114, such as the Internet or an intranet. In addition, a patient may seek healthcare services by going to a physician's office 106, a hospital 112, or a remote healthcare site 122.

At a physician's office 106, a patient 102 may receive services from a physician 108 or office staff 110. Furthermore, the physician 108 or office staff 110 may retrieve, access, view or use patient information maintained on a database or an information system, which typically includes, but is not limited to, a personal computer or terminal 104 connected to a communications network 114.

A patient 102 may additionally seek healthcare services from a hospital 112 and may generally interact with hospital employees such as registration personnel 120 and scheduling personnel 118. Both registration personnel 120 and scheduling personnel 118 may have access to terminals or personal computers 113 and 115 that are connected to the hospital database and information system server(s) 116. The patient 102 may also interface with a kiosk 120, which could be a terminal or personal computer that is connected to the hospital database and information system server(s) 116. The hospital database and information system server(s) 116 may also be connected to a communications network 114.

A patient 102 may also seek healthcare services from a remote healthcare site 122 and interface with registration staff 120 using a terminal or personal computer 123. The patient 102 may optionally access a kiosk 124 for his/her healthcare service needs. Each of the terminal or personal computer 123 and the optional kiosk 124 may be connected to a communications network 114.

In this environment, databases and information systems may be maintained by each of the physician's office 106 and the hospital 112. The systems may be separate and independent. While the information and procedures performed vary from location to location, the need exists for communication and sharing of data between systems in order to effectively and efficiently service the patient. Without the ability to share information, the independent database and information systems are restrictive and fail to provide a complete picture for patient care.

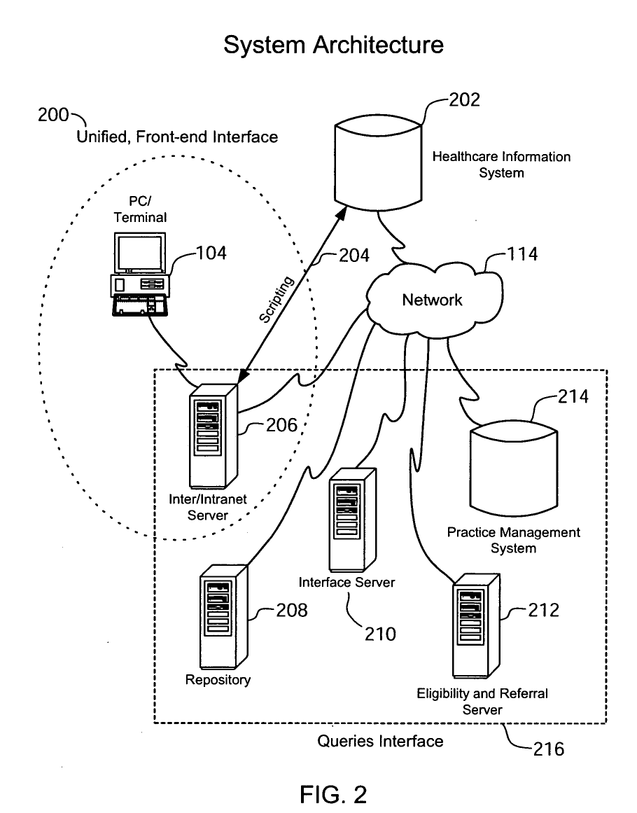

FIG. 2 illustrates a preferred system architecture for realizing the invention, including a unified front-end interface 200, a queries interface 216, a communications network 114, and a healthcare information system 202. The unified front-end interface 200 may include a terminal or personal computer 104 and an Internet/intranet server 206, and may be connected to the healthcare information system 202 by a scripting interface 204 and/or the communication network 114. The queries interface 216 may include the Internet/intranet server 206, a repository server 208, an interface server 210, an eligibility and referral server 212, and a practice management system 214. The queries interface 216 may be connected to the healthcare information system 202 through the communications network 114.

The Internet/intranet server 206 may be a computer server including, but not limited to, Microsoft's Internet Information Services servers, Novell servers, and Linux-based servers. The repository server 208 may include, but is not limited to, a SQL Server offered by Oracle Corporation. The repository may be implemented using standard database technology, as a table stored in a memory, or as a combination of these elements or other data storage elements.

The interface server 210 may include, but is not limited to, HL7-compliant messaging products offered by Hewlett-Packard Corporation, IBM Corporation, Dell Corporation, Gateway Corporation and others. The communications network 114 may be configured as, for example, a wireless network, a local area network or a wide area network. The healthcare information system 202 may include, but is not limited to, products offered by MediTech, SMS, HBOC (part of McKesson), UCR, Scheduling.com, Tempus and others. The practice management system 214 may include, but is not limited to, products offered by NextGen, HBOC, SMS, LSS, Cemer and others. The eligibility and referral server 212 may include, but is not limited to, products offered by NextGen, Passport Health, WebMD and others.

In one embodiment, the unified front-end interface 200 may include a compilation of code that provides a user interface and interfaces to various databases. The code for the unified front-end interface 200 may be written in a variety of computer programming languages including, but not limited to, JAVA, C++ or HTML. The queries interface 216 may also be written in a variety of computer languages including, but not limited to, SQL, JAVA or HL7-compliant messaging, and may control the distribution of data among at least one independent database or healthcare information system. The scripting interface 204 may be developed using standard or proprietary software tools including, but not limited to, products sold under the trade names or trademarks of Boston Workstation, Microscript or Scriptlink.

The preferred system utilizes a hospital patient services unified front-end interface 200, a repository 208 coupled to the hospital patient services unified front end interface 200, and a plurality of healthcare system processes accessing both internal and external database and information systems, some of which may be independent (e.g., not controlled or maintained locally). The plurality of healthcare system processes preferably includes at least one of the following: flexible sequencing, access to medical necessity, insurance verification, procedure ordering, appointment scheduling, physician reference information, patient instructions, patient information, exception reporting, results reporting, registration and order entry. This information may also be stored in temporary records in the repository from the plurality of healthcare system processes.

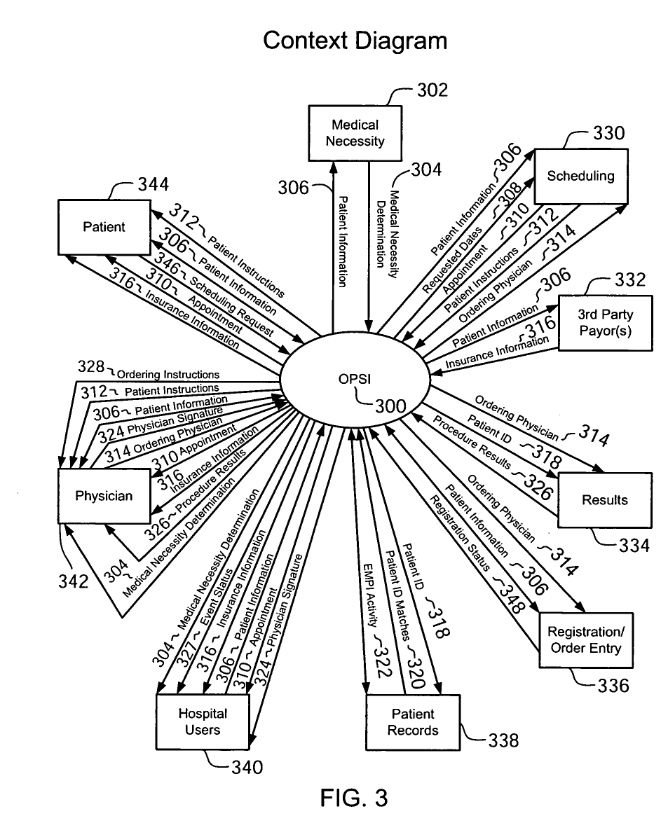

FIG. 3 illustrates a context diagram showing relationships between a preferred embodiment system and key external elements. By way of illustration, the present invention is referred to as an Outpatient Service Improvement (OPSI) system 300. In one embodiment, the OPSI system 300 may be used to manage outpatient services. However, the OPSI system 300 is not limited to that application and may be used in managing services in a hospital, physician's office, or other healthcare facility or environment.

The OPSI system 300 preferably includes the unifying front-end interface 200 and repository 206 functionality and communicates with representative external elements, such as some or all of those illustrated in FIG. 3. Patient information 306 and scheduling requests 346 may be sent to the OPSI system 300 from a patient database 344 for processing. The OPSI system 300 may reply with insurance information 316, which typically consists of referral, eligibility and authorization information, appointment information 310, and patient instructions 312 to the patient database 344. If patient information 306 has been updated or changed in a separate database or information system, the OPSI system 300 preferably transmits the patient information 306 to the patient database 344 as well.

The medical necessity database 302 may be located in a separate database and may include diagnosis and procedure code information. A diagnosis code is an alphanumeric identifier associated with a specific diagnosis (e.g., 100 may be used as the code for a broken wrist) and a procedure code is an alphanumeric identifier associated with a specific procedure (e.g., 1000 may be used as the code for a wrist X-ray).

The OPSI system 300 preferably transfers patient information 306 to the medical necessity database 302 and receives a medical necessity determination 304. The OPSI system 300 may then transmit the medical necessity determination 304 to other affected database and information systems, such as a hospital system 340 or a physician system 342.

The OPSI system 300 may transmit patient information 306, requested dates 308, and ordering physician information 314 to a scheduling system 330. The scheduling system may confirm an appointment 310 and return patient instructions 312 to the OPSI system 300 for transmission to affected systems, such as the physician system 342 or a patient system 344.

The OPSI system 300 preferably transmits patient information 306 to a third party payer system 332. The third party payer system 332 may respond with insurance information 316 to the OPSI system 300.

The OPSI system 300 preferably provides a patient identifier 318 and ordering physician information 314 to a results system 334. The results system 334 may respond by sending procedure results 326 to the OPSI system 300.

OPSI 300 preferably provides patient information 306 and ordering physician information 314 to a registration/order entry system 336. The registration/order entry system 336 may transmit registration status 348 and patient information 306 to the OPSI system 300.

The OPSI system 300 preferably provides a patient identifier 318 to a patient records system 338, which returns patient ID matches 320 to the OPSI system 300. Should multiple records be identified, the EMPI (Electronic Master Patient Index) activity 322 may update database and information systems in the patient records system 338 and the OPSI system 300. These updated values may be transmitted to other independent database and information systems.

A hospital system 340 preferably provides patient information 306 to the OPSI system 300. The OPSI system 300 may return an event status 326, insurance information 316, a medical necessity determination 304, a physician signature 324 and/or appointment information 310 to the hospital system 340.

A physician system 342 preferably provides patient information 306, a physician signature 324, and/or ordering physician information 314 to the OPSI system 300. The OPSI system 300 may return ordering instructions 328, patient instructions 312, appointment information 310, insurance information 316, procedure results 326, and a medical necessity determination 304 to the physician system 342.

In a common scenario, the patient 102 meets with his/her physician 108 on a particular health concern. Patient information 306 is retrieved and reviewed by the physician 108. Upon completion of the examination, the physician may recommend additional procedures such as an X-ray, MRI, or other tests performed at a hospital 112. The physician's office 106 submits a request via the OPSI system 300 including patient information 306, the physician's signature 324, and ordering physician information 314. The patient 102 may place a scheduling request 346 for preferred times and dates for the procedure. The OPSI system 300 may then transmit the patient information 306 to one or more of, for example: (i) the medical necessity system 302 where the medical necessity determination 304 is made and returned to the physician's system 342; (ii) the scheduling system 330 where the requested dates 308 may be considered before confirming an appointment 310 to the patient system 344 and the physician system 342; (iii) the third party payer system 332 where insurance information 316 is confirmed; and (iv) the hospital system 340 where event status information 326, insurance information 316, the medical necessity determination 304, and appointment information 310 may be available. As information is passed between a plurality of independent databases and information systems, the OPSI system 300 may save pertinent information in a repository providing relevant information to all affected systems.

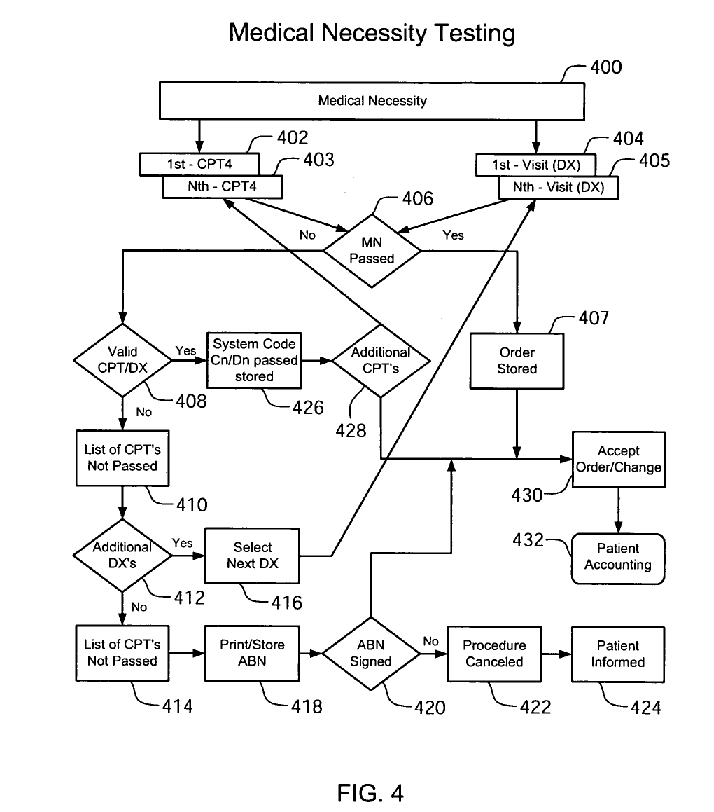

FIG. 4 represents a preferred medical necessity flow diagram 400 in which the initial step of identifying the patient, as well as the corresponding diagnosis and procedure, has been entered. CPT4 data 402 may list the procedure(s) to be performed. Diagnoses (DX) 404 may represent information provided by the physician regarding the patient's condition. CPT4 data 402 and DX data 404 may be matched and cross-referenced to determine whether the medical necessity test is passed 406. If the medical necessity test is passed, information relating to the passing of the test may be stored 407. The CPT4 and DX data may be tested 408 to verify that the CPT4 402 and DX 404 codes are valid. If the codes are valid, system codes 426 may be saved for each of the technical (hospital) and professional (physician) components. If additional CPT4 403 and DX 405 records need to be reviewed 428, the system may accept additional codes. If not, the system may accept orders or changes 430 and transmit the information to patient accounting 432. If either the CPT code 402 or the DX code 404 is invalid 408, the system may provide a list of CPT codes 402 that do not pass 410. Additional DX codes may be tested 412 by selecting the next DX code 416 if such codes are provided. Each additional DX code may be used to perform a medical necessity test 406. If no additional DX codes 404 are provided, the system may capture the list of CPTs that do not pass 414 for both the technical and professional components. The list of CPTs 414 may then be printed and/or stored 418 before determining if the ABN (Advanced Beneficiary Notification) is signed 420. If the ABN is signed, the system may accept orders/changes 430 and enter patient accounting 432. If the ABN is not signed, the procedure may be canceled 422, and the patient may be informed 424.

If the medical necessity test 400 fails, the patient 102 has the option of paying for the procedure directly, in which case the patient 102 completes and signs the ABN indicating that selection. In the event the medical necessity test 400 fails and the patient 102 declines to pay for the procedure, the procedure may be cancelled.

The preferred medical necessity flow 400 may receive diagnosis and procedure codes for hospital patient testing. Such information may be stored in the repository. A query may be submitted comparing the diagnosis codes to the procedure codes used in determining medical necessity. The system may receive a pass or fail indication from the first database and may store the indication in the repository. A pass indication may suggest that the procedure code is consistent with the diagnosis code and therefore denote that the procedure is medically necessary. A fail indicator may suggest that the procedure code is inconsistent with the diagnosis code. In this case, the procedure may be medically unnecessary or inappropriate. The preferred medical necessity flow 400 may display indicator information at a plurality of locations including, but not limited to, the physician office 106 or hospital 112. In a preferred embodiment, an exception report containing the indicator information may be generated prior to the time a patient 102 presents himself/herself for the procedure. This exception report may contain information including, but not limited to, unsigned orders, failed medical necessity tests, appointments without eligibility referral, orders received without appointment, if eligibility is not passed, referrals required but not requested, and a list of pending referrals. Generally, this information may be stored in the repository substantially close to the time of physician ordering. The repository may be monitored for exceptions, and a report may be generated, indicating that an exception has occurred, prior to the time a patient 102 presents himself for service at the hospital 112.

In some situations, the patient 102 may refuse acceptance of service. In this case, the preferred medical necessity flow 400 may store the patient notification of refusal of acceptance of service in the repository and may display it at the physician office 108. Furthermore, in a preferred embodiment of the medical necessity flow 400, the pass indication may contain separate subindications for a technical and a professional component for medical necessity determination. In this embodiment, the invention transmits matched diagnosis and procedure codes to a second database so that the matched diagnosis and procedure codes may be retrieved and displayed on a hospital system 340.

Preferably, the OPSI system 300 is capable of performing a medical necessity test 400 for a hospital patient 102 prior to the patient presenting himself at the hospital. The OPSI system 300 preferably supports a user interface for receiving and presenting information regarding the hospital patient 102 and a proposed procedure to a user, a first database interface for interfacing to a first database containing records that indicate whether or not the patient 102 has insurance, a second database interface for interfacing to a second database containing records indicating criteria for medical necessity, and a query generator for receiving information from the user through the user interface and generating a first query to the first database and a second query to the second database, where the present invention determines whether the patient 102 has insurance and, if so, determines if the proposed procedure passes a medical necessity test.

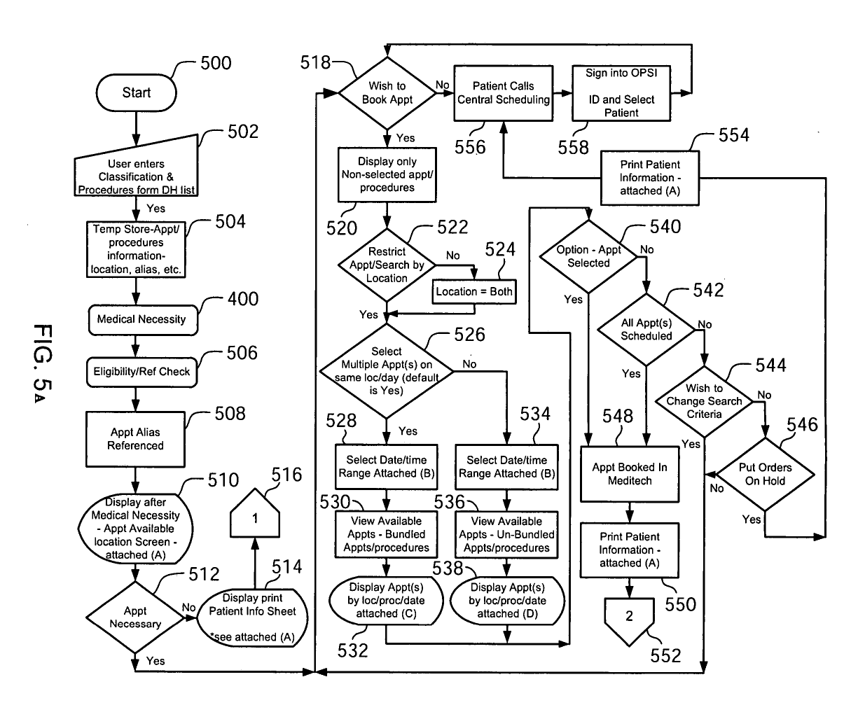

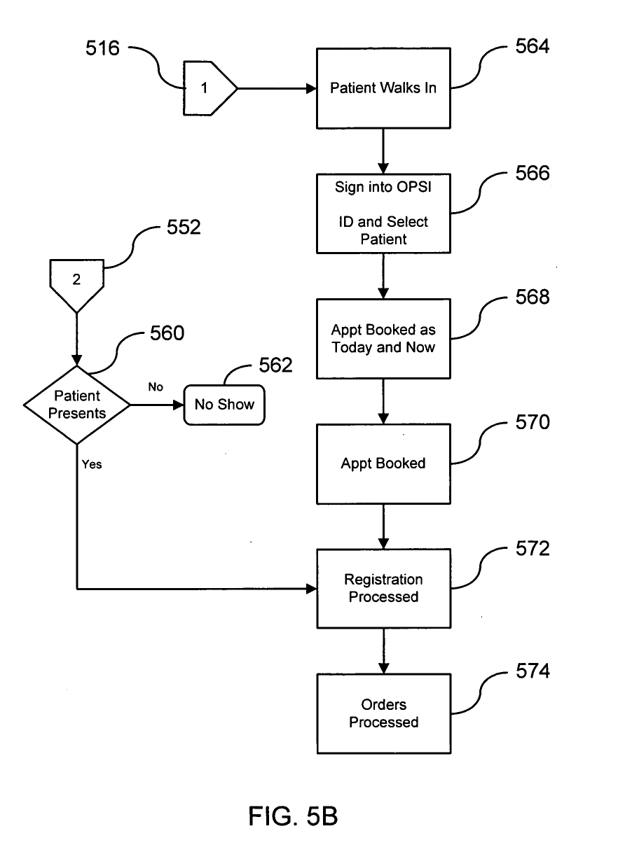

FIGS. 5A and 5B illustrate the preferred OPSI procedure crosswalk flow. The crosswalk flow describes a method of associating orders with scheduling and patient information. At the start 500, a user may enter specific classification and procedure information 502, which may be placed in a temporary storage location 504. The medical necessity test 400 and the eligibility/referral (insurance information) test 506 may then be performed. Upon completing these tests, an appointment alias 508 may be referenced. A logical test may be performed to determine if an appointment is necessary 510. If an appointment is not necessary 512, patient information may be displayed or printed 514. In this case, the patient need not be scheduled in advance because a walk-in procedure is permitted. A preferred flow for this sequence follows in FIG. 5B where the patient walks in 558 and signs in 560 to the OPSI system 300. The OPSI user may enter that the appointment is booked for today at the current time (today and now) 562, and the appointment may be booked 564. The registration 566 and any physician orders 568 may then be processed. Returning to FIG. 5A, if an appointment is necessary 512, the system may ask the patient whether he/she wishes to book an appointment 518. If the patient decides to book an appointment, a list of appointment times available for the requested procedures may be displayed 520. The OPSI user may select whether or not to restrict the appointment 522. In some situations, it may be advantageous or necessary to perform certain procedures at specific locations. If such a requirement does not exist, the user may choose to not restrict the location at which the procedures are performed 524. The user may then select times and locations for one or more appointment(s) 526. The system defaults for the procedures being on the same day at the same location. If the user opts to have one or more appointment(s) on the same day at the same location 526, the user may select the desired date and/or time range 528, as well as view available appointments 530 for bundled services (e.g., procedures having a specific sequence or time order). This information may then be displayed 532. If the user decides to have one or more appointment(s) on different days or at different locations 526, a user may select the desired date and time range 534 and view available appointments for unbundled procedures 536, and that information may then be displayed 538. Once the appointment(s) are displayed (532 and 538), a user may select an appointment 540. After the OPSI user selects an appointment, the appointment may be booked in a healthcare information system 548, and the patient information 550 may be printed. The remaining sequence in this embodiment is illustrated in FIG. 5B beginning at 552. When the patient presents himself/herself 554 for the procedure, the registration may be processed 566 and the physician orders may be processed 568. If the patient does not present himself/herself, the appointment may be recorded as a no show 556.

Returning to FIG. 5A, if the OPSI user does not select an appointment 540, the user may determine if every appointment should be selected 542. If the OPSI user has selected times and locations for all appointments requiring scheduling, the appointment(s) may be booked in a healthcare information system 548, and the patient information 550 may be printed. The remaining sequence is illustrated in FIG. 5B beginning at 552. When the patient presents himself/herself 554 for the procedure, the registration may be processed 566 and the physician orders may be processed 568. If the patient does not present himself/herself, the appointment may be recorded as a no show 556.

Returning to FIG. 5A, if the patient 102 must still schedule or more appointments 542, the user may be presented with the option of changing search criteria 544. If a user changes the search criteria 544, the system may allow the user to attempt to book an appointment 518 again. If a user elects not to change the search criteria 544, the system may ask whether the user wishes to put his/her orders on hold 546. If the user does not decide to put his/her orders on hold, the system may ask the user to book an appointment 518 again. If the user puts his/her orders on hold 546, the OPSI system 300 may print or otherwise display or transmit patient information 554 while retaining a local copy of the patient information. Once the patient is able to identify suitable dates for the remaining procedure(s), the patient may access central scheduling 556, identify himself/herself through the OPSI sign-in procedure 558 and retrieve patient information. A patient 102 may then book an appointment 518 and follow the sequence of scheduling events.

A unique feature of the OPSI system 300 is its ability to automatically schedule procedures in their proper order, if any, regardless of how the procedures were originally entered. When a request for multiple procedures is received, the OPSI system 300 preferably accesses at least one database or information system to determine the required sequence of procedures. The required sequence may then be used when scheduling and confirming procedure appointments. This feature may improve operational efficiencies while enhancing patient service experiences.

Another feature of the preferred OPSI system 300, and, in particular, the preferred crosswalk procedure, is the ability of the system 300 to retrieve an order information dataset from a first database, retrieve a scheduling information dataset from the first database, create an association between the order information dataset and the scheduling information dataset, and display the order information dataset and associated scheduling information dataset. The OPSI system 300 is preferably able to receive a procedure code associated with a patient, associate the procedure code with an order information dataset, retrieve the order information dataset from a first database, retrieve a scheduling information dataset from the first database, retrieve an association between the order information dataset and the scheduling information dataset, create a patient specific information dataset based on the association between the order information dataset and the scheduling information dataset, and transmit the patient specific information dataset associated with the order information dataset to at least one external database. Subsequently, the preferred OPSI system 300 may retrieve the patient specific information dataset associated with the order information dataset from the at least one external database and transmit the patient specific information dataset to a healthcare information system.

Furthermore, the preferred OPSI system 300 includes a computer-based method for associating orders with scheduling and patient information for pre-operative procedures wherein the at least one external database includes an event notification database. The preferred OPSI system 300 creates a patient specific information dataset based on the association between the order information dataset and scheduling information dataset prior to the procedure and transmit the information to the event notification database. The event notification database may then notify impacted parties (e.g., the patient or the physician). As a result, any potential issues or concerns may be addressed prior to the procedure.

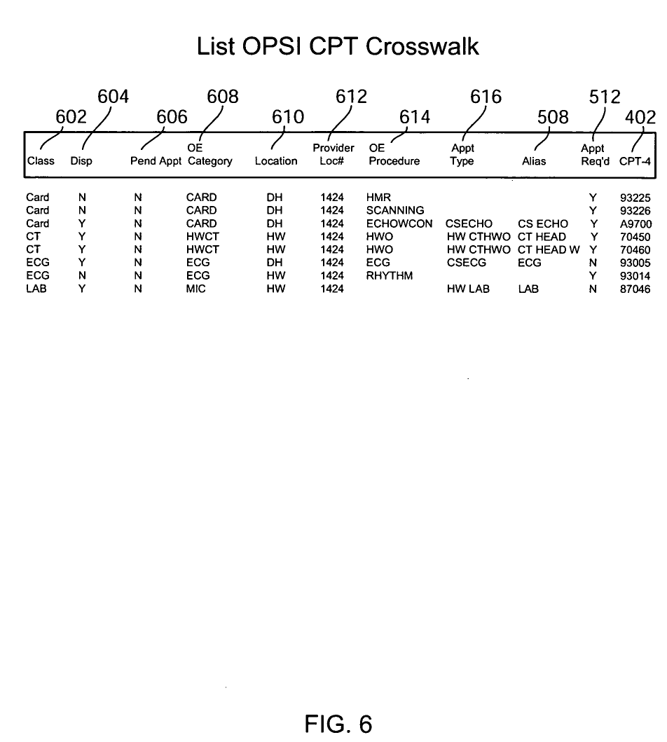

FIG. 6 illustrates exemplary field and data information used to create a cross-reference, link or association between a plurality of independent database and healthcare information systems. This is also referred to as crosswalk data. The crosswalk data may be stored in tabular form or as part of a database. Referring to FIG. 6, the class field 602 may define the type of procedure to be performed (e.g., Lab, Cardiologist, ECG). The display field 604 may indicate whether or not certain information is viewable in the OPSI system 300. The pending appointment field 606 may indicate whether or not a patient appointment has been confirmed. The OE field 608 may identify a broad classification for the procedure. The location field 610 may denote the physical location at which the procedure is to be performed. The provider location number 612 may list an identifier assigned by a third party payer to the provider. The OE procedure field 614 may denote the specific procedure to be performed. The appointment type field 616 may provide information on the procedure and the location at which it will be performed. The alias field 508 may link procedures across multiple locations. The appointment required field 512 may provide information on whether the patient must undergo advanced registration or whether the patient may walk-in. The CPT-4 field 402 may provide industry-standard procedure information.

The exemplary fields illustrated in FIG. 6 may provide information from a variety of independent database and healthcare information systems. By cross-referencing, linking or associating these fields, the OPSI system 300 may effectively and efficiently transfer, access, update, synchronize, store and retrieve information located or used in a plurality of independent database and healthcare information systems. The crosswalk feature provides the ability to retrieve the order information dataset including, but not limited to, the broad procedure category 608, the CPT code 402, and specific procedure information from a first database. The crosswalk feature may then retrieve the scheduling information dataset including, but not limited to, the location 610, the appointment type 616, sequencing information, and patient instructions from a second database. An association between the order information dataset and the scheduling information dataset may be created and displayed.

Furthermore, the crosswalk feature may receive a procedure code associated with a specific patient. This procedure code may also be associated with the order information dataset. The crosswalk feature may retrieve the association between the order information dataset and the scheduling information dataset. The crosswalk feature may create a patient-specific scheduling information dataset based on the association between the order information dataset and the scheduling information dataset.

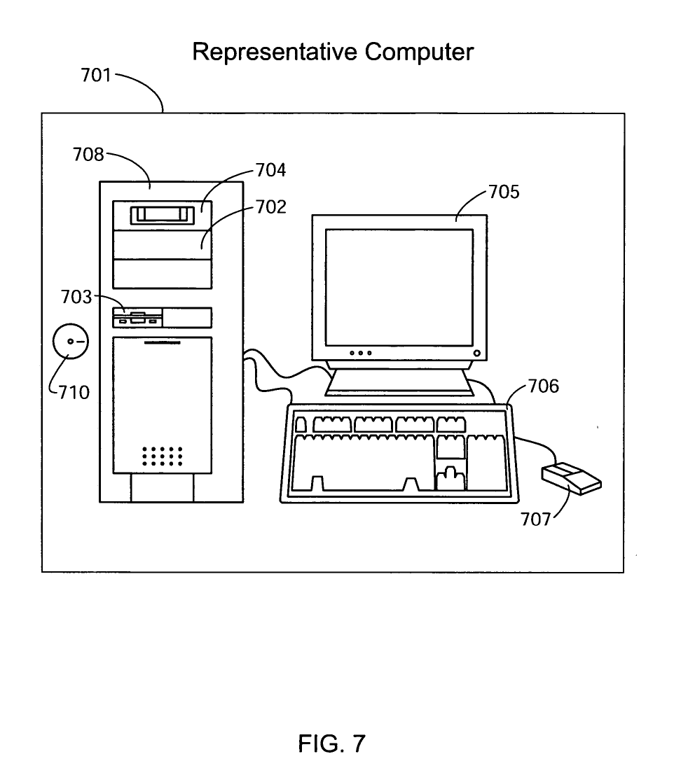

FIG. 7 illustrates an exemplary computer of a type suitable for carrying out and/or comprising the system elements of the invention. Viewed externally in FIG. 7, a computer system designated by reference numeral 701 has a central processing unit located within a housing 708 and disk drives 703 and 704. Disk drives 703 and 704 are merely symbolic of a number of disk drives that may be accommodated by the computer system. Typically these disk drives may include a hard disk drive and optionally one or more floppy disk drives such as 703 and/or one or more CD-ROMs, CD-Rs, CD-RWs or digital video disk (DVD) devices indicated by slot 704. The number and types of drives typically varies with different computer configurations. Additional disk drives may be located in slot 702. Disk drives 703 and 704 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer 701 may include, be connected to or deliver signals to a display 705 upon which graphical, video and/or alphanumeric information may be displayed. The display 705 may be any device capable of presenting visual images, such as a television screen, a computer monitor, a projection device, a handheld or other microelectronic device, a headset or a helmet worn by the user having video display capabilities. The computer 701 may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 706 and/or an optional a directing device 707, such as a remote control, mouse, joystick, touch pad, track ball, steering wheel, remote control or any other type of pointing or directing device, may be provided as input devices to interface with the central processing unit.

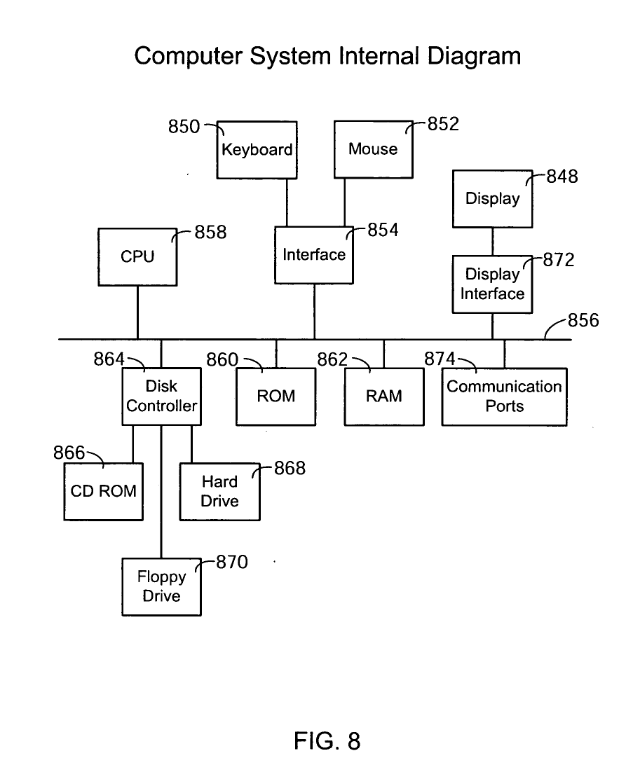

FIG. 8 illustrates a block diagram of the internal hardware of the exemplary computer of FIG. 7. A system bus 856 may serve as the main data passing mechanism interconnecting the other components of the computer 701. A CPU 858 is the central processing unit of the computer system 701. The CPU 858 may execute a program by performing calculations and logic operations. Read only memory (ROM) 860 and random access memory (RAM) 862 may constitute the main memory of the computer 701.

A disk controller 864 may be the interface between one or more disk drives and the system bus 856. These disk drives may be external or internal floppy disk drives such as 870, external or internal CD-ROM, CD-R, CD-RW or DVD drives such as 866, or external or internal hard drives 868. As indicated previously, these various disk drives and disk controllers are optional devices.

Program instructions may be stored in the ROM 860 and/or the RAM 862. Optionally, program instructions may be stored on a computer readable carrier such as a floppy disk or a digital disk or other recording medium, a communications signal, or a carrier wave.

Returning to FIG. 8, a display interface 872 may permit information from the system bus 856 to be displayed on a display 848 in audio, graphic and/or alphanumeric format. Communication with external devices may optionally occur using various communication ports such as 874.

In addition to the standard components of the computer, the preferred computer 701 may also include an interface 854 that allows for data input through a keyboard 850 or other input device and/or a directional or pointing device 852, such as a remote control, pointer, mouse or joystick.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A computer system for managing patient services, the computer system comprising:
a patient services unified front-end interface serving as a unified front-end for patient services management; and
a repository coupled to the patient services unified front-end interface and to a plurality of healthcare system processes.

2. The computer system of claim 1, wherein the plurality of healthcare system processes includes at least one of the following: flexible sequencing, access to medical necessity, insurance verification, procedure ordering, appointment scheduling, physician reference information, patient instructions, patient information, exception reporting, results reporting, registration and order entry.

3. The computer system of claim 1, wherein the repository contains temporary records obtained from the plurality of healthcare system processes.

4. The computer system of claim 1, wherein the patient services unified front-end interface provides a point of access for at least one of the following locations: health care provider offices, remote locations, and points of service.

5. A patient services improvement software system comprising:
a front-end software module providing an interface to health care workers for administrating a plurality of patient services;
a repository module storing a set of patient related information; and
a plurality of communications interfaces providing for communications between the front-end software module and a plurality of external databases and the repository module and the plurality of external databases.

6. The computer system of claim 5, wherein the plurality of patient services include at least one of the following: flexible sequencing, access to medical necessity, insurance verification, procedure ordering, appointment scheduling, physician reference information, patient instructions, patient information, exception reporting, results reporting, registration and order entry.

7. A computer-based method for managing medical necessity testing in a health care environment, the method comprising the steps of:
receiving one or more diagnosis codes and one or more procedure codes for patient testing from a physician location;
storing the one or more diagnosis codes and the one or more procedure codes in a repository;
forming a query to a first database, wherein the query requests a comparison of the one or more diagnosis codes and the one or more procedure codes to determine medical necessity;
receiving a pass/fail indicator from the first database; and
storing the pass/fail indicator in the repository.

8. The method of claim 7, further comprising the step of displaying the pass/fail indicator at the physician location.

9. The method of claim 7, further comprising the steps of:
retrieving the pass/fail indicator from the repository at the time of patient presentation; and
displaying the pass/fail indicator at the time of patient presentation.

10. The method of claim 7, further comprising the step of generating an exception report containing the pass/fail indicator prior to the time of patient presentation at a health care facility.

11. The method of claim 7, further comprising the steps of:
receiving notification of refusal of acceptance of service from a patient;
storing said notification of refusal of acceptance of service in said repository; and
displaying said notification of refusal of acceptance of service at the physician location.

12. The method of claim 7 wherein the pass/fail indicator includes separate subindicators for a technical component and a professional component.

13. The method of claim 7, further comprising the step of transmitting matched diagnosis and procedure codes to a second database.

14. The method of claim 13, further comprising the step of retrieving matched diagnosis and procedure codes from the second database for display at a health care facility.

15. A computer system for performing a medical necessity test for a patient prior to the patient presenting, the computer system comprising:
a user interface for receiving and presenting information regarding the patient and a proposed procedure to a user;
a first database interface for interfacing to a first database, wherein the first database contains records indicating whether or not the patient has insurance;
a second database interface for interfacing to a second database, wherein the second database contains records indicating criteria for medical necessity; and
a query generator for receiving information from the user through the user interface, generating a first query to the first database and a second query to the second database, wherein the first query determines if the patient has insurance, and, if so, the second query determines if the proposed procedure passes a medical necessity test.

16. A computer-based method for reducing the occurrence of multiple patient identifiers in a health care environment, the method comprising the steps of:
receiving patient search criteria from a physician's office;
transmitting a query to a first database wherein the query contains the patient search criteria;
receiving a command to add a new patient when no perceived matches exist between the patient search criteria and a plurality of patient records;
presenting to the user at least one logical test regarding the patient's past activity; and
receiving an answer to the at least one logical test, wherein the answer is “yes” if the patient has had past activity, and wherein the answer is “no” if the patient has not had past activity;
if the answer is “yes,” preventing the entry of a new patient record; and
if the answer is “no,” permitting the creation of a new patient record.

17. The method of claim 16, further comprising the step of presenting a list of existing patient records when the answer is “yes.”

18. The method of claim 16, further comprising the step of:
allowing creation of a new patient record when the answer to the logical test is “no;” storing the new patient record in the repository; and
checking the new patient record against patient records in a second database.

19. The method of claim 18, further comprising the step of approving filing of the new patient record in the second database when the checking step indicates that the new patient record does not exist.

20. The method of claim 18, further comprising the steps of:
identifying multiple records within the second database based on the checking step; and
deleting the multiple records in the second database prior to the patient presenting.

21. The method of claim 18, further comprising the steps of:
recording information in the repository regarding the detection of multiple records in the second database; and
informing the first database that a multiple record has been detected.

22. The method of claim 18, further comprising the steps of:
recording information in the repository regarding the detection of multiple records in the second database; and
informing at least one database administrator of possible multiple medical records.

23. A computer-based system for reducing the occurrence of multiple patient identifiers in a health care environment, the system comprising:
a user interface for receiving patient search criteria, receiving a new user command presenting at least one new user logical test to the user, receiving at least one response from the at least one new user logical test, and for receiving new patient information;
a query generator capable of transmitting a query to a first database wherein the query contains the patient search criteria;
a logical test generator capable of generating at least one health care activity logical test regarding the patient's past health care activity, wherein the at least one health care activity logical test returns a positive result if the patient has had past health care activity, and wherein the at least one health care activity logical test returns a negative result if the patient has not had past health care activity; and
a repository for storing the new patient information when the response to the at least one health care activity logical test is a positive result.

24. The computer system of claim 23, further comprising a communications interface to a second database.

25. The computer system of claim 24, wherein the communications interface to the second database is capable of generating a query to compare the new patient information with patient records contained within the second database.

26. A computer-based method for managing exceptions to patient processes in a health care environment, the method comprising the steps of:
populating a repository with patient related information at substantially the time of a healthcare provider's order, the patient related information including whether an exception occurred, wherein exceptions include unsigned orders, failed medical necessity tests, appointments scheduled without an eligibility referral, order received without a scheduled appointment, eligibility failure, an order without a required referral and a list of pending referrals;
monitoring the repository for exceptions; and
generating a report indicating that an exception has occurred, wherein the generating takes place before the patient presents for service at the health care facility.

27. A method for associating orders with scheduling and patient information, the method comprising the steps of:
retrieving an order information dataset from a first database;
retrieving a scheduling information dataset from the first database;
creating an association between the order information dataset and the scheduling information dataset; and
displaying the order information dataset and associated scheduling information dataset.

28. The method of claim 27, further comprising the steps of:
receiving a procedure code associated with a patient;
associating the procedure code with the order information dataset;
retrieving the association between the order information dataset and the scheduling information dataset;
creating a patient specific scheduling information dataset based on the association between the order information dataset and the scheduling information dataset; and
transmitting the patient specific scheduling information dataset associated with the order information dataset to at least one external database.

29. A computer-based method for associating orders with scheduling and patient information, the method comprising the steps of:
receiving a procedure code associated with a patient;
associating the procedure code with an order information dataset;
retrieving the order information dataset from a first database;
retrieving a scheduling information dataset from the first database;
retrieving an association between the order information dataset and the scheduling information dataset;
creating a patient specific information dataset based on the association between the order information dataset and the scheduling information dataset; and
transmitting the patient specific information dataset associated with the order information dataset to at least one external database.

30. The computer-based method of claim 29, further comprising the steps of:
subsequently retrieving the patient specific information dataset associated with the order information dataset from the at least one external database; and
transmitting the patient specific information dataset to a healthcare information system.

31. A computer system for associating orders with scheduling and patient information, the computer system comprising:
a first query generator for generating a first query wherein the first query generator is capable of generating one or more queries to retrieve a scheduling information dataset and a order information dataset, and
a crosswalk database containing an association between the scheduling information dataset and the order information dataset.

32. The computer system of claim 31, further comprising:
a user interface for receiving a procedure code associated with a patient;
a second query generator for generating a second query wherein the second query retrieves the association between the order information dataset and the scheduling information dataset; and
a patient specific scheduling information generator capable of creating a patient specific scheduling information dataset based on the procedure code and the association between the order information dataset and the scheduling information dataset.

33. The computer system of claim 32, further comprising an external database interface capable of transmitting the patient specific scheduling information dataset to an external database.

34. The computer-based method of claim 29, wherein the procedure code represents a pre-operative procedure.

35. The computer-based method of claim 29, wherein the at least one external database includes an event notification database.
